(19) United States
(12) Patent Application Publication
(10) Pub. No.: US 2019/0239118 A1
(43) Pub. Date: Aug. 1, 2019

(54) TECHNIQUES FOR MANAGING VEHICLE-TO-EVERYTHING (V2X) CAPABILITY CONVERGENCE PROTOCOL IN NEW RADIO (NR)

(71) Applicant: QUALCOMM Incorporated, San Diego, CA (US)

(72) Inventors: Sudhir Kumar Baghel, Hillsborough, NJ (US); Junyi Li, Chester, NJ (US); Shailesh Patil, San Diego, CA (US); Michaela Vanderveen, Tracy, CA (US); Hong Cheng, Bridgewater, NJ (US)

(21) Appl. No.: 16/159,240

(22) Filed: Oct. 12, 2018

Related U.S. Application Data
(60) Provisional application No. 62/623,653, filed on Jan. 30, 2018.

(51) Int. Cl. H04W 28/06; H04W 4/40; H04W 8/24; H04L 29/06; H04W 4/08

(52) U.S. Cl. CPC H04W 28/06; H04W 4/40; H04L 69/04; H04L 69/08; H04W 4/08; H04W 8/245

(57) ABSTRACT

Techniques for managing vehicle-to-everything (V2X) capability convergence protocol in new radio (NR) are described. For example, the techniques may include identifying a reference user equipment capability, identifying capability information of a first user equipment and broadcasting/transmitting a capability message using the reference user equipment capability, wherein the capability message may include the capability information of the first user equipment.

### CROSS REFERENCES

The present Application for Patent claims priority to U.S. Provisional Patent Application No. 62/623,653 by Sudhir Kumar Baghel et al., entitled “Techniques for Managing Vehicle-to-Everything (V2X) Capability Convergence Protocol in New Radio (NR),” filed Jan. 30, 2018, assigned to the assignee hereof, which is incorporated by reference in its entirety.

### BACKGROUND

### Field of the Disclosure

The following relates generally to wireless communication, and more specifically to techniques for managing vehicle-to-everything (V2X) capability convergence protocol in new radio (NR).

### Description of Related Art

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as a Long Term Evolution (LTE) systems or LTE-Advanced (LTE-A) systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

These multiple access technologies have been adopted in various telecommunication standards to provide a common protocol that enables different wireless devices to communicate on a municipal, national, regional, and even global level. For example, a fifth generation (5G) wireless communications technology (which can be referred to as new radio (NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-low latency (ULL) and/or ultra-reliable-low latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in NR communications technology and beyond may be desired.

For example, 5G NR will provide more flexibility in wireless communications. This increased flexibility can apply to different aspects of wireless communications, including the various mechanisms and techniques used for scheduling or conveying (e.g., signaling) information about assignments and/or feedback of transmissions. Accordingly, there is a need for new techniques managing vehicle-to-everything (V2X) capability convergence protocol in new radio (NR).

### SUMMARY

The described techniques relate to improved methods, systems, devices, or apparatuses that manage vehicle-to-everything (V2X) capability convergence protocol in new radio (NR).

In an aspect of the present disclosure, a method for managing vehicle-to-everything (V2X) capability convergence protocol in new radio (NR) may include identifying a reference user equipment capability, identifying capability information of a first user equipment, and broadcasting a capability message using the reference user equipment capability, the capability message includes the capability information of the first user equipment. For example, the reference user equipment capability may be a minimum user equipment capability that may be supported by all user equipments in a wireless communication network. In an example, the reference user equipment capability may be dynamically configured and/or preconfigured.

In an aspect of the present disclosure, the capability message may further include capability information of a group of user equipments within a communication coverage area. The capability message may further include timing information associated with the capability information of a group of user equipments within the communication coverage area. The timing information may indicate a timing of when the capability information of a group of user equipments within the communication coverage area was last received by the first user equipment. The method for manage vehicle-to-everything (V2X) capability convergence protocol in new radio (NR) may further include determining at least one of a capability upgrade time boundary or a capability downgrade time boundary based at least in part on the timing information associated with the capability information of a group of user equipments within the communication coverage area. The capability message may further include a group identification of a group of user equipments, the group identification is associated with a multicast session between the group of user equipments. Broadcasting a capability message may include periodically broadcasting the capability message. The method for managing vehicle-to-everything (V2X) capability convergence protocol in new radio (NR) may further include broadcasting/transmitting an acknowledging message, the acknowledgement message indicates that the first user equipment adjusted to operate in a level of capability associated with a communication coverage area. The acknowledgement message may be broadcasted/transmitted to a group of user equipments in multicast session. The capability message may be broadcasted as at least one of a physical layer message, a MAC layer message, a RRC message or a NAS message.

In an aspect of the present disclosure, a method for managing vehicle-to-everything (V2X) capability convergence protocol in new radio (NR) may include receiving, by a first user equipment, a capability message, the capability message includes capability information of a second user equipment, identifying, by the first user equipment, capability information of the first user equipment, comparing, by the first user equipment, the capability information of the first user equipment with the capability information of the second user equipment, and determining, by the first user equipment, a level of capability to operate in based at least in part on the comparison of the capability information of the first user equipment with the capability information of the second user equipment.

In an aspect of the present disclosure, the capability message may further include capability information of a group of user equipments within a communication coverage area. The method may also include comparing the capability information of a group of user equipments within the communication coverage area with the capability information of the first user equipment. The method may further include determining the level of capability to operate in based at least in part on the comparison between the capability information of a group of user equipments within the communication coverage area and the capability information of the first user equipment. The method may include adjusting the first user equipment to operate in the determined level of capability. Adjusting the first user equipment to operate in the determined level of capability may include adjusting the first user equipment to operate in the determined level of capability at a time boundary of a communication coverage area. The time boundary of a communication coverage area may include at least one of a capability upgrade time boundary or a capability downgrade time boundary. The capability upgrade time boundary may occur at a lower frequency than the capability downgrade time boundary. The method may further include receiving an acknowledgement message from the second user equipment, the acknowledgement message indicating that the second user equipment adjusted to operate in a level of capability associated with a communication coverage area.

In an aspect of the present disclosure, an apparatus for managing vehicle-to-everything (V2X) capability convergence protocol in new radio (NR) may include a processor, a memory in electronic communication with the processor; and instructions stored in the memory and operable, when executed by the processor, to cause the apparatus to: identify a reference user equipment capability, identify capability information of a first user equipment, and broadcast a capability message using the reference user equipment capability, the capability message includes the capability information of the first user equipment.

In an aspect of the present disclosure, the capability message may further include capability information of a group of user equipments within a communication coverage area. The capability message may further include timing information associated with the capability information of a group of user equipments within the communication coverage area. The timing information may indicate a timing of when the capability information of a group of user equipments within the communication coverage area was last received by the first user equipment. The apparatus may further include determining at least one of a capability upgrade time boundary or a capability downgrade time boundary based at least in part on the timing information associated with the capability information of a group of user equipments within the communication coverage area. The capability message may further include a group identification of a group of user equipments, the group identification is associated with a multicast session between the group of user equipments. Broadcasting/transmitting a capability message may include periodically broadcasting/transmitting the capability message. The apparatus may further include instructions stored in the memory and operable, when executed by the processor, to cause the apparatus to broadcast/transmit an acknowledging message, the acknowledgement message may indicate that the first user equipment adjusted to operate in a level of capability associated with a communication coverage area. The acknowledgement message may be broadcasted/transmitted to a group of user equipments in multicast session. The capability message may be broadcasted/transmitted as at least one of a physical layer message, a MAC layer message, a RRC message or a NAS message.

In an aspect of the present disclosure, an apparatus for managing vehicle-to-everything (V2X) capability convergence protocol in new radio (NR) may include a processor, a memory in electronic communication with the processor; and instructions stored in the memory and operable, when executed by the processor, to cause the apparatus to: receive a capability message, the capability message includes capability information of a second user equipment, identify capability information of the first user equipment, compare the capability information of the first user equipment with the capability information of the second user equipment, and determine a level of capability to operate in based at least in part on the comparison of the capability information of the first user equipment with the capability information of the second user equipment.

In an aspect of the present disclosure, the capability message may further include capability information of a group of user equipments within a communication coverage area. The apparatus may further include instructions stored in the memory and operable, when executed by the processor, to cause the apparatus to: compare the capability information of a group of user equipments within the communication coverage area with the capability information of the first user equipment. The apparatus may further include instructions stored in the memory and operable, when executed by the processor, to cause the apparatus to: determine the level of capability to operate in based at least in part on the comparison between the capability information of a group of user equipments within the communication coverage area and the capability information of the first user equipment. The apparatus may further include instructions stored in the memory and operable, when executed by the processor, to cause the apparatus to: adjust the first user equipment to operate in the determined level of capability. Adjust the first user equipment to operate in the determined level of capability may include adjust the first user equipment to operate in the determined level of capability at a time boundary of a communication coverage area. The time boundary of a communication coverage area may include at least one of a capability upgrade time boundary or a capability downgrade time boundary. The capability upgrade time boundary may occur at a lower frequency than the capability downgrade time boundary. The apparatus may further include instructions stored in the memory and operable, when executed by the processor, to cause the apparatus to: receive an acknowledgement message from the second user equipment, the acknowledgement message indicating that the second user equipment adjusted to operate in a level of capability associated with a communication coverage area.

In an aspect of the present disclosure, an apparatus for managing vehicle-to-everything (V2X) capability convergence protocol in new radio (NR) may include means for identifying a reference user equipment capability, means for identifying capability information of a first user equipment, and means for broadcasting a capability message using the reference user equipment capability, the capability message includes the capability information of the first user equipment.

In an aspect of the present disclosure, the capability message may further include capability information of a group of user equipments within a communication coverage area. The capability message may further include timing information associated with the capability information of a group of user equipments within the communication coverage area. The timing information may indicate a timing of when the capability information of a group of user equipments within the communication coverage area was last received by the first user equipment. The apparatus may further include means for determining at least one of a capability upgrade time boundary or a capability downgrade time boundary based at least in part on the timing information associated with the capability information of a group of user equipments within the communication coverage area. The capability message may further include a group identification of a group of user equipments, the group identification may be associated with a multicast session between the group of user equipments. Broadcasting a capability message may include periodically broadcasting the capability message. The apparatus may further include means for broadcasting/transmitting an acknowledging message, the acknowledgement message may indicate that the first user equipment adjusted to operate in a level of capability associated with a communication coverage area. The acknowledgement message may be broadcasted/transmitted to a group of user equipments in multicast session. The capability message may be broadcasted as at least one of a physical layer message, a MAC layer message, a RRC message or a NAS message.

In an aspect of the present disclosure, an apparatus for managing vehicle-to-everything (V2X) capability convergence protocol in new radio (NR) may include means for receiving a capability message, the capability message includes capability information of a second user equipment, means for identifying capability information of the first user equipment, means for comparing, by the first user equipment, the capability information of the first user equipment with the capability information of the second user equipment, and means for determining a level of capability to operate in based at least in part on the comparison of the capability information of the first user equipment with the capability information of the second user equipment.

In an aspect of the present disclosure, the capability message may further include capability information of a group of user equipments within a communication coverage area. The apparatus may further include means for comparing the capability information of a group of user equipments within the communication coverage area with the capability information of the first user equipment. The apparatus may include means for determining the level of capability to operate in based at least in part on the comparison between the capability information of a group of user equipments within the communication coverage area and the capability information of the first user equipment. The apparatus may further include means for adjusting the first user equipment to operate in the determined level of capability. The means for adjusting the first user equipment to operate in the determined level of capability may include means for adjusting the first user equipment to operate in the determined level of capability at a time boundary of a communication coverage area. The time boundary of a communication coverage area may include at least one of a capability upgrade time boundary or a capability downgrade time boundary. The capability upgrade time boundary may occur at a lower frequency than the capability downgrade time boundary. The apparatus may further include means for receiving an acknowledgement message from the second user equipment, the acknowledgement message indicating that the second user equipment adjusted to operate in a level of capability associated with a communication coverage area.

In an aspect of the present disclosure, a non-transitory computer readable medium storing code for managing vehicle-to-everything (V2X) capability convergence protocol in new radio (NR), the code including instructions executable by a processor to: identify a reference user equipment capability, identify capability information of a first user equipment, and broadcast a capability message using the reference user equipment capability, the capability message includes the capability information of the first user equipment.

In an aspect of the present disclosure, the capability message may further include capability information of a group of user equipments within a communication coverage area. The capability message may further include timing information associated with the capability information of a group of user equipments within the communication coverage area. The timing information may indicate a timing of when the capability information of a group of user equipments within the communication coverage area was last received by the first user equipment. The non-transitory computer readable medium may further include code executable by a processor to: determine at least one of a capability upgrade time boundary or a capability downgrade time boundary based at least in part on the timing information associated with the capability information of a group of user equipments within the communication coverage area. The capability message may further include a group identification of a group of user equipments, the group identification may be associated with a multicast session between the group of user equipments. Broadcasting a capability message may include periodically broadcasting the capability message. The non-transitory computer readable medium may further include code executable by a processor to: broadcast/transmit an acknowledging message, the acknowledgement message indicates that the first user equipment adjusted to operate in a level of capability associated with a communication coverage area. The acknowledgement message may be broadcasted/transmitted to a group of user equipments in multicast session. The capability message may be broadcasted as at least one of a physical layer message, a MAC layer message, a RRC message or a NAS message.

In an aspect of the present disclosure, a non-transitory computer readable medium storing code for managing vehicle-to-everything (V2X) capability convergence protocol in new radio (NR), the code may include instructions executable by a processor to: receive a capability message, the capability message includes capability information of a second user equipment, identify capability information of the first user equipment, compare the capability information of the first user equipment with the capability information of the second user equipment; and determine a level of capability to operate in based at least in part on the comparison of the capability information of the first user equipment with the capability information of the second user equipment.

In an aspect of the present disclosure, the capability message may further include capability information of a group of user equipments within a communication coverage area. The non-transitory computer readable medium may further include code executable by a processor to: compare the capability information of a group of user equipments within the communication coverage area with the capability information of the first user equipment. The non-transitory computer readable medium may further include code executable by a processor to: determine the level of capability to operate in based at least in part on the comparison between the capability information of a group of user equipments within the communication coverage area and the capability information of the first user equipment. The non-transitory computer readable medium may further include code executable by a processor to: adjust the first user equipment to operate in the determined level of capability. The code for adjusting the first user equipment to operate in the determined level of capability may include code for adjusting the first user equipment to operate in the determined level of capability at a time boundary of a communication coverage area. The time boundary of a communication coverage area may include at least one of a capability upgrade time boundary or a capability downgrade time boundary. The capability upgrade time boundary may occur at a lower frequency than the capability downgrade time boundary. The non-transitory computer readable medium may further include code executable by a processor to: receive an acknowledgement message from the second user equipment, the acknowledgement message indicating that the second user equipment adjusted to operate in a level of capability associated with a communication coverage area.

Some examples of the method, apparatus, and non-transitory computer-readable medium described above may include operations, features, means, or instructions for determining a target device for the first signal, and the first signal may be transmitted to the target device.

### BRIEF DESCRIPTION OF THE DRAWINGS

FIG. 1 illustrates an example of a system for wireless communication that supports management of vehicle-to-everything (V2X) capability convergence protocol in new radio (NR) in accordance with various aspects of the present disclosure.

FIGS. 2A, 2B, 2C, and 2D are diagrams illustrating examples of a DL frame structure, DL channels within the DL frame structure, an UL frame structure, and UL channels within the UL frame structure that supports management of vehicle-to-everything (V2X) capability convergence protocol in new radio (NR) in accordance with various aspects of the present disclosure.

FIG. 3 is a diagram illustrating an example of a base station and a user equipment (UE) that supports management of vehicle-to-everything (V2X) capability convergence protocol in new radio (NR) in accordance with various aspects of the present disclosure.

FIG. 4 illustrates a block diagram illustrating an example sidelink communication structure that supports management of vehicle-to-everything (V2X) capability convergence protocol in new radio (NR) in accordance with various aspects of the present disclosure.

FIG. 5 illustrates a call flow diagram of a centralized management of vehicle-to-everything (V2X) capability convergence protocol in new radio (NR) in accordance with various aspects of the present disclosure.

FIG. 6 illustrates a call flow diagram of a distributed management of vehicle-to-everything (V2X) capability convergence protocol in new radio (NR) in accordance with various aspects of the present disclosure.

FIG. 7 shows a diagram of a system 700 including a device 705 that manages vehicle-to-everything (V2X) capability convergence protocol in new radio (NR) in accordance with various aspects of the present disclosure.

FIG. 8 shows a diagram of a system 800 including a device 805 that manages vehicle-to-everything (V2X) capability convergence protocol in new radio (NR) in accordance with various aspects of the present disclosure.

FIG. 9 shows a flowchart illustrating a method 900 for management of vehicle-to-everything (V2X) capability convergence protocol in new radio (NR) in accordance with various aspects of the present disclosure.

FIG. 10 shows a flowchart illustrating a method 1000 for management of vehicle-to-everything (V2X) capability convergence protocol in new radio (NR) in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

In cellular communication networks, wireless devices may generally communicate with each other via one or more network entities such as a base station or scheduling entity. Some networks may additionally or alternatively support device-to-device (D2D) communication that enables discovery of, and communication with nearby devices using a direct link between devices (i.e., without passing through a base station, relay, or other node). D2D communication can enable mesh networks and device-to-network relay functionality. Some examples of D2D technology include Bluetooth pairing, Wi-Fi Direct, Miracast, and LTE-D. D2D communication may also be called point-to-point (P2P) or sidelink communication.

D2D communication may be implemented using licensed or unlicensed bands. D2D communication can avoid the overhead involving the routing to and from the base station. Therefore, D2D communication can provide better throughput, lower latency, and/or higher energy efficiency. MuLTEFire is a form of Long-term Evolution (LTE) network that can support D2D communication using unlicensed frequency bands. MuLTEFire can be used in any unlicensed spectrum where there is contention for use of the spectrum, although deployments are initially expected in the 5 GHz unlicensed band and potentially also in the 3.5 GHz shared band in the U.S. MuLTEFire implements a listen-before-talk (LBT) strategy for coexistence management. For example, when UEs accessing a channel in a MuLTEFire communication system, the UEs may perform a first LBT process (e.g., 25 μs) if within the base station TxOP). The UEs may perform a second LBT process (e.g., Cat. 4 LBT with random backoff) if not within the base station TxOP. Also, UEs may be configured to start the LBT process at different starting positions in order to reduce collisions between the UEs.

A type of D2D communication may include vehicle-to-everything (V2X) communication. For example, the V2X communication plays an important role in helping autonomous vehicles communicating with each other. For example, autonomous vehicles may include a plurality of sensors, e.g., lidar, radar, cameras etc. The plurality of sensors of the autonomous vehicles may be line of sight, however, V2X communication may allow autonomous vehicles to communicate with each other for non-line of sight cases. For example, when two vehicles approach an intersection, various information gathered by the plurality of sensors of the two vehicles may be shared via V2X communication, even though the two vehicles may not have direct line of sight with each other. Also, various information gather by the plurality of sensors of a vehicle may be shared with other vehicles or devices within a communication coverage area.

During V2X communication, various vehicles or UEs may be implemented or configured with different levels of capabilities. For example, when a vehicle or UE sends a V2X message using a first level of capability, the receiving vehicle or UE may not properly receive (e.g., demodulate and/or decode) the V2X message because the receiving vehicle or UE may be operating at a second level of capability (e.g., the second level of capability is lower than the first level of capability). Thus, the transmitting vehicle or UE in a V2X communication may not be aware of the level of capability of a receiving vehicle or UE. In order to enable V2X communication between vehicles or UEs, all vehicles or UEs may be forced (e.g., by an operator or transportation agencies) to operate at a minimum capability, even though some vehicles or UEs may be implemented or configured with higher capability, in order to ensure compatibility. Aspects of the present disclosure provide techniques for managing V2X capability convergence protocol in new radio (NR) in order to allow the vehicles or UEs to conduct V2X communication at a capability higher than the minimum capability when the vehicles or UEs are implemented or configured with a higher V2X communication capability.

Various aspects of techniques for managing V2X capability convergence protocol in new radio (NR) may include a vehicle or UE broadcasting a capability message using a reference user equipment capability. For example, the reference user equipment capability may be a minimum user equipment capability supported by all vehicles or UEs. For example, the reference user equipment capability may be a minimum user equipment capability that may be supported by all user equipments in a wireless communication network. In an example, the reference user equipment capability may be dynamically configured and/or preconfigured. The capability message broadcasted using the reference user equipment capability may include various information. For example, the capability message may include a capability information (e.g., a level of user equipment capability) of a vehicle or UE and/or capability information (e.g., a level of user equipment capability) of a group of vehicles or UEs within a communication coverage area. In another example, the capability message may include a group identification (ID) of a group of vehicles or UEs, where the group ID may be associated with a multicast session between the group of vehicles or UEs. In other examples, the capability message may include timing information associated with the capability information (e.g., a level of user equipment capability) of a group of vehicles or UEs within a communication coverage area. The timing information may indicate a timing of when the capability information (e.g., a level of user equipment capability) of a group of vehicles or UEs within a communication coverage area was last received by the broadcasting vehicles or UEs.

One or more vehicles or UEs within a communication coverage area may receive one or more broadcasted capability messages. The vehicles or UEs within the communication coverage area may identify a capability information (e.g., a level of user equipment capability) of a vehicle or UE and/or capability information (e.g., a level of user equipment capability) of a group of vehicles or UEs within a communication coverage area included in the capability message. The receiving vehicle or UE within the communication coverage area may adjust an operation (e.g., a level of user equipment capability) based at least in part on the capability information (e.g., a level of user equipment capability) of a broadcasting vehicle or UE and/or capability information (e.g., a level of user equipment capability) of a group of vehicles or UEs within a communication coverage area.

For example, if the received capability information (e.g., a level of user equipment capability) of a group of vehicles or UEs within a communication coverage area is lower than a level of user equipment capability that the receiving vehicle or UE is currently operating in, then the receiving vehicle or UE may lower its level of user equipment capability and operate in a level of user equipment capability of a group of vehicles or UEs within a communication coverage area. In another example, if the received capability information (e.g., a level of user equipment capability) of a group of vehicles or UEs within a communication coverage area is higher than a level of user equipment capability that the receiving vehicle or UE is currently operating in, then the receiving vehicle or UE may increase its level of user equipment capability (e.g., as long as the receiving vehicle or UE supports a level of user equipment capability of a group of vehicles or UEs within a communication coverage area) and operate in a level of user equipment capability of a group of vehicles or UEs within a communication coverage area. In other examples, if the capability information (e.g., a level of user equipment capability) of a vehicle or UE is lower than the capability information (e.g., a level of user equipment capability) of a group of vehicles or UEs within a communication coverage area and a level of user equipment capability that the receiving vehicle or UE is currently operating in, then the receiving vehicle or UE may lower its level of user equipment capability and operate in a level of user equipment capability of a the vehicle or UE.

Vehicles and UEs within a communication coverage area may perform the adjustment of an operation (e.g., changing a level of user equipment capability) contemporaneously. The adjustment of an operation (e.g., changing a level of user equipment capability) of a vehicle or UE may be performed contemporaneously at a time boundary of a communication coverage area. For example, all vehicles or UEs within a communication coverage area may perform an adjustment of an operation (e.g., changing a level of user equipment capability) at a time boundary of the communication coverage area. For example, different time boundaries may be configured for different adjustment of an operation of vehicles or UEs within a communication coverage area. For example, an upgrade capability time boundary may be configured for increasing a level of user equipment capability for the vehicles and UEs within a communication coverage area. In another example, a downgrade capability time boundary may be configured for lowering a level of user equipment capability for the vehicles and UEs within a communication coverage area. A frequency of the occurrences of the upgrade capability time boundary and the downgrade capability time boundary may vary. For example, a communication coverage area may be configured with a higher frequency of occurrences of downgrade capability time boundaries than upgrade capability time boundaries. In another example, a communication coverage area may be configured with a high frequency of occurrences of upgrade capability time boundaries than downgrade capability time boundaries. In other example, a communication coverage area may be configured with same frequency of occurrences of upgrade capability time boundary and downgrade capability time boundary.

Various aspects of techniques for managing V2X capability convergence protocol in new radio (NR) may include a vehicle or UE broadcasting/transmitting an acknowledgement (ACK) message. The broadcasting ACK message may indicate that the broadcasted vehicle or UE has adjusted a level of user equipment capability to operate in a level of user equipment capability of a group of vehicles or UEs within a communication coverage range that may be visible (e.g., within a communication coverage area) to the broadcasting vehicle or UE. As described above, the adjustment of a level of user equipment capability may be performed at a time boundary configured or implemented for a communication coverage area. The ACK message may be received by one or more vehicles or UEs within a communication coverage area then the one or more vehicles or UEs within the communication coverage area may adjust a level of user capability to operate in a level of user equipment capability indicated in the ACK message.

V2X communication may be configured for a licensed radio spectrum and/or a shared radio frequency spectrum. For example, a shared radio frequency spectrum is used for at least a portion of communications in a wireless communication system. In some examples, the shared radio frequency spectrum may be used for Long Term Evolution (LTE) or LTE-Advanced (LTE-A) communications, Licensed Assisted Access (LAA) communications, enhanced LAA (eLAA) communications, or MuLTEFire communications. The shared radio frequency spectrum may be used in combination with, or independent from, a dedicated radio frequency spectrum. The dedicated radio frequency spectrum may include a radio frequency spectrum licensed to particular users for particular uses. The shared radio frequency spectrum may include a radio frequency spectrum available for Wi-Fi use, a radio frequency spectrum available for use by different radio access technologies, or a radio frequency spectrum available for use by multiple mobile network operators (MNOs) in an equally shared or prioritized manner.

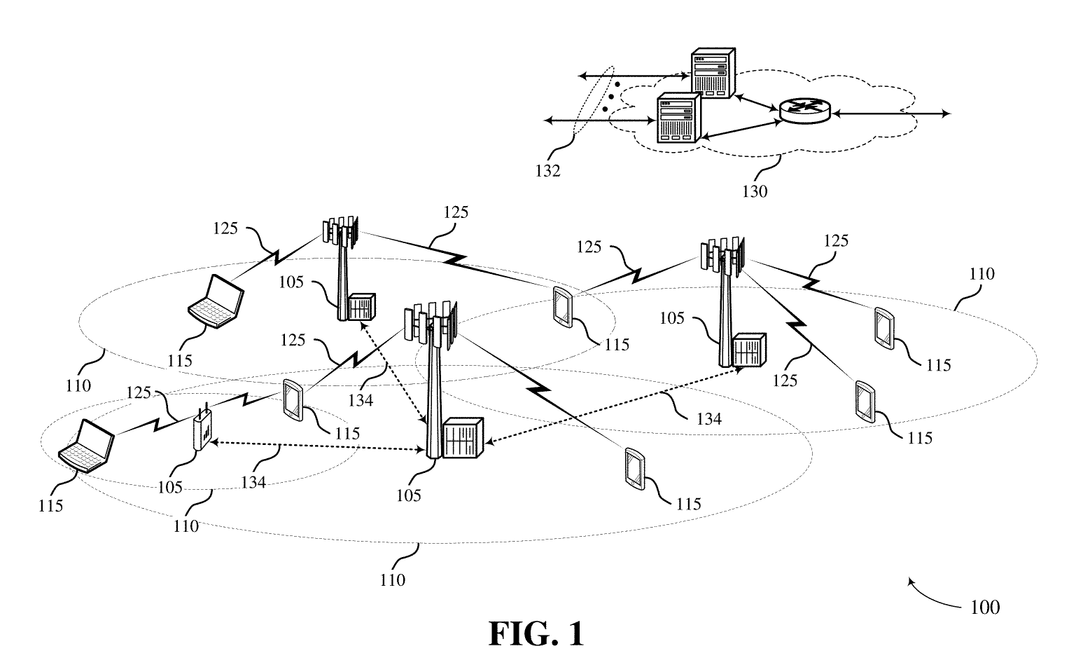

FIG. 1 illustrates an example of a wireless communications system 100 that supports management of V2X capability convergence protocol in new radio (NR) in accordance with various aspects of the present disclosure. The wireless communications system 100 may include base stations 105, UEs 115, and a core network 130. In some examples, the wireless communications system 100 may be a Long-Term Evolution (LTE) network, an LTE-Advanced (LTE-A) network, or a New Radio (NR) network. In some cases, wireless communications system 100 may support enhanced broadband communications, ultra-reliable (e.g., mission critical) communications, low latency communications, or communications with low-cost and low-complexity devices.

In some examples, the wireless communication network 100 may be or include one or any combination of communication technologies, including a new radio (NR) or 5G technology, a Long-Term Evolution (LTE) or LTE-Advanced (LTE-A) or MuLTEFire technology, a Wi-Fi technology, a Bluetooth technology, or any other long or short range wireless communication technology. In LTE/LTE-A/MuLTEFire networks, the term evolved node B (eNB) may be generally used to describe the base stations 105, while the term UE may be generally used to describe the UEs 110. The wireless communication network 100 may be a heterogeneous technology network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions, from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115 (e.g., for multiple-input multiple-output (MIMO) operations such as spatial multiplexing, or for directional beamforming). However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed/shared radio frequency spectrum bands. For example, wireless communications system 100 may employ LTE License Assisted Access (LTE-LAA) or LTE-Unlicensed (LTE-U) radio access technology or MuLTEFire radio access technology or NR technology in an unlicensed/shared radio frequency band such as the 5 GHz ISM band. When operating in unlicensed/shared radio frequency spectrum bands, wireless devices such as base stations 105 and UEs 115 may employ listen-before-talk (LBT) procedures to ensure a frequency channel is clear before transmitting data. In some cases, operations in unlicensed/shared radio frequency bands may be based on a CA configuration in conjunction with CCs operating in a licensed band. Operations in unlicensed/shared radio frequency spectrum may include downlink transmissions, uplink transmissions, peer-to-peer transmissions, or a combination of these. Duplexing in unlicensed/shared radio frequency spectrum may be based on frequency division duplexing (FDD), time division duplexing (TDD), or a combination of both.

In some cases, the antennas of a base station 105 or UE 115 may be located within one or more antennas or antenna arrays, which may support MIMO operations such as spatial multiplexing, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

MIMO wireless systems use a transmission scheme between a transmitting device (e.g., a base station 105) and a receiving device (e.g., a UE 115), where both transmitting device and the receiving device are equipped with multiple antennas. MIMO communications may employ multipath signal propagation to increase the utilization of a radio frequency spectrum band by transmitting or receiving different signals via different spatial paths, which may be referred to as spatial multiplexing. The different signals may, for example, be transmitted by the transmitting device via different antennas or different combinations of antennas. Likewise, the different signals may be received by the receiving device via different antennas or different combinations of antennas. Each of the different signals may be referred to as a separate spatial stream, and the different antennas or different combinations of antennas at a given device (e.g., the orthogonal resource of the device associated with the spatial dimension) may be referred to as spatial layers.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a direction between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain phase offset, timing advance/delay, or amplitude adjustment to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may multiple use antennas or antenna arrays to conduct beamforming operations for directional communications with a UE 115. For instance, signals may be transmitted multiple times in different directions, which may include a signal being transmitted according to different beamforming weight sets associated with different directions of transmission. A receiving device (e.g., a UE 115, which may be an example of a mmW receiving device) may try multiple receive beams when receiving various signals from the base station 105, such as synchronization signals or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Ts=1/30,720,000 seconds. Time intervals of a communications resource may be organized according to radio frames each having a duration of 10 milliseconds (Tf=307200*Ts). The radio frames may be identified by a system frame number (SFN) ranging from 0 to 1023. Each frame may include ten subframes numbered from 0 to 9, and each subframe may have a duration of 1 millisecond. A subframe may be further divided into two slots each having a duration of 0.5 milliseconds, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols and in some instances, a symbol of a mini-slot or a mini-slot may be the smallest unit of scheduling. Each symbol may vary in duration depending on the subcarrier spacing or frequency band of operation, for example. Some wireless communications systems may implement slot aggregation in which multiple slots or mini-slots may be aggregated together for communication between a UE 115 and a base station 105.

A resource element may consist of one symbol period (e.g., a duration of one modulation symbol) and one subcarrier (e.g., a 15 kHz frequency range). A resource block may contain 12 consecutive subcarriers in the frequency domain (e.g., collectively forming a “carrier”) and, for a normal cyclic prefix in each orthogonal frequency-division multiplexing (OFDM) symbol, 7 consecutive OFDM symbol periods in the time domain (1 slot), or 84 total resource elements across the frequency and time domains. The number of bits carried by each resource element may depend on the modulation scheme (the configuration of modulation symbols that may be applied during each symbol period). Thus, the more resource elements that a UE 115 receives and the higher the modulation scheme (e.g., the higher the number of bits that may be represented by a modulation symbol according to a given modulation scheme), the higher the data rate may be for the UE 115. In MIMO systems, a wireless communications resource may refer to a combination of a radio frequency spectrum band resource, a time resource, and a spatial resource (e.g., spatial layers), and the use of multiple spatial layers may further increase the data rate for communications with a UE 115.

The term “carrier” refers to a set of radio frequency spectrum resources having a defined organizational structure for supporting uplink or downlink communications over a communication link 125. For example, a carrier of a communication link 125 may include a portion of a radio frequency spectrum band that may also be referred to as a frequency channel. In some examples a carrier may be made up of multiple sub-carriers (e.g., waveform signals of multiple different frequencies). A carrier may be organized to include multiple physical channels, where each physical channel may carry user data, control information, or other signaling.

The organizational structure of the carriers may be different for different radio access technologies (e.g., LTE, LTE-A, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, or 20 MHz). In some examples the system bandwidth may refer to a minimum bandwidth unit for scheduling communications between a base station 105 and a UE 115. In other examples a base station 105 or a UE 115 may also support communications over carriers having a smaller bandwidth than the system bandwidth. In such examples, the system bandwidth may be referred to as “wideband” bandwidth and the smaller bandwidth may be referred to as a “narrowband” bandwidth. In some examples of the wireless communications system 100, wideband communications may be performed according to a 20 MHz carrier bandwidth and narrowband communications may be performed according to a 1.4 MHz carrier bandwidth.

Devices of the wireless communications system 100 (e.g., base stations or UEs 115) may have a hardware configuration that supports communications over a particular carrier bandwidth, or may be configurable to support communications over one of a set of carrier bandwidths. For example, base stations 105 or UEs 115 may perform some communications according to a system bandwidth (e.g., wideband communications), and may perform some communications according to a smaller bandwidth (e.g., narrowband communications). In some examples, the wireless communications system 100 may include base stations 105 and/or UEs that can support simultaneous communications via carriers associated with more than one different bandwidth.

Wireless communications system 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed/shared radio frequency spectrum or shared radio frequency spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may use a combination of licensed, shared, and unlicensed/shared radio frequency spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

Referring again to FIG. 1, in various aspects, a first UE 115 may be configured to perform device-to-device (D2D) communications with a second UE 115. In aspects, the D2D communication may include a vehicle-to-everything (V2X) communication or a vehicle-to-vehicle (V2V) communication. In aspects, techniques for management of V2X capability convergence protocol in new radio (NR) may be configured as described herein.

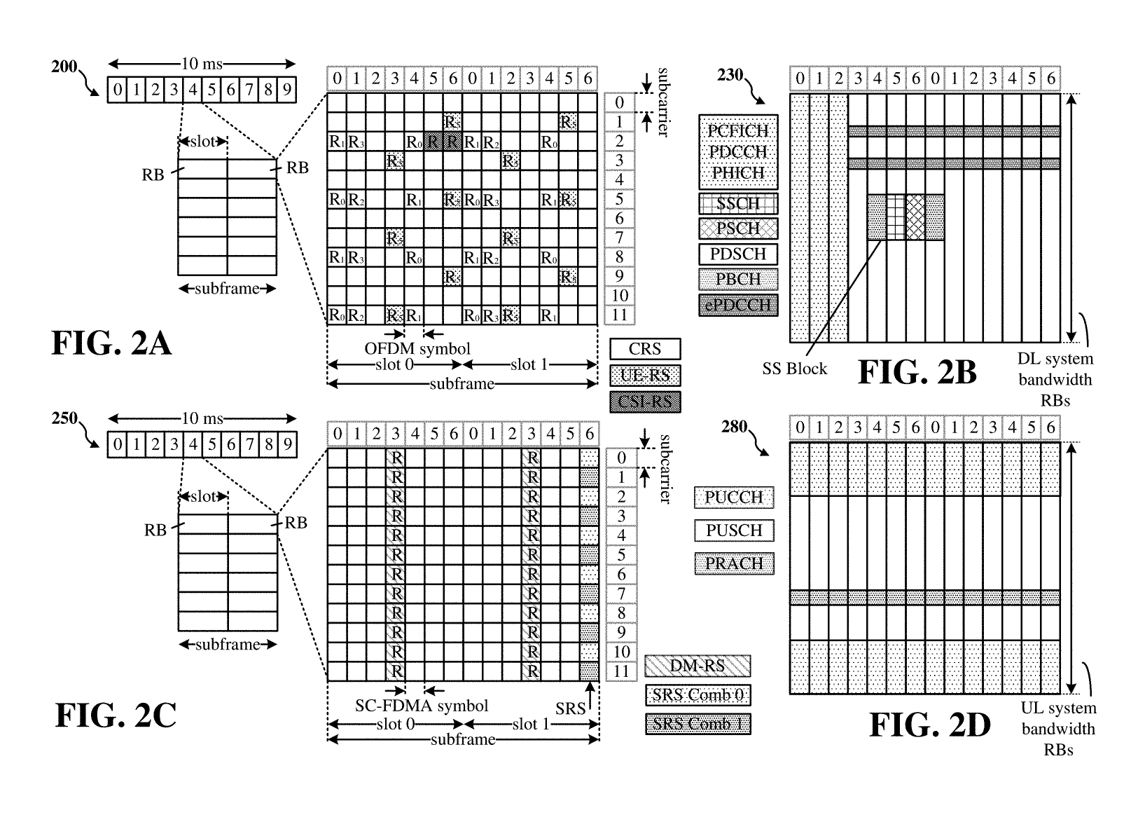

FIG. 2A is a diagram 200 illustrating an example frame structure of one or more downlink (DL) frames in accordance with various aspects of the present disclosure. FIG. 2B is a diagram 230 illustrating an example of channels within the frame structure of a DL frame in accordance with various aspects of the present disclosure. FIG. 2C is a diagram 250 illustrating an example frame structure of one or more uplink (UL) frames in accordance with various aspects of the present disclosure. FIG. 2D is a diagram 280 illustrating an example of channels within the frame structure of a UL frame in accordance with various aspects of the present disclosure. Other wireless communication technologies may have a different frame structure and/or different channels. A frame (10 ms) may be divided into 10 equally sized subframes. Each subframe may include two consecutive time slots. A resource grid may be used to represent the two-time slots, each time slot including one or more time concurrent resource blocks (RBs) (also referred to as physical RBs (PRBs)). The resource grid is divided into multiple resource elements (REs). For a normal cyclic prefix, an RB contains 12 consecutive subcarriers (e.g., for 15 kHz subcarrier spacing) in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (e.g., also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. FIG. 2D illustrates an example of various channels within an UL subframe of a frame. A physical random-access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

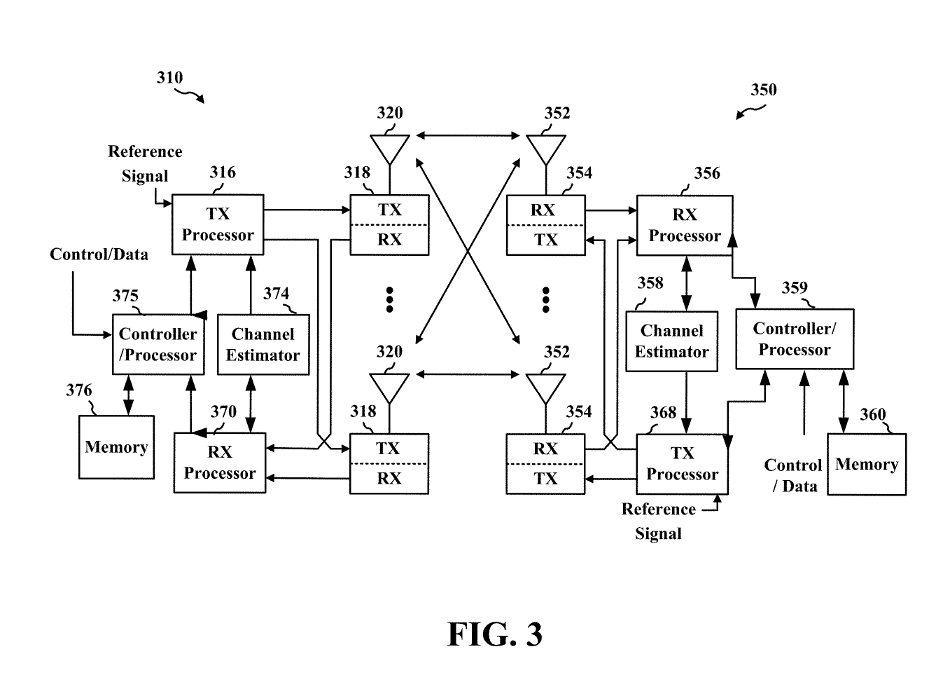

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

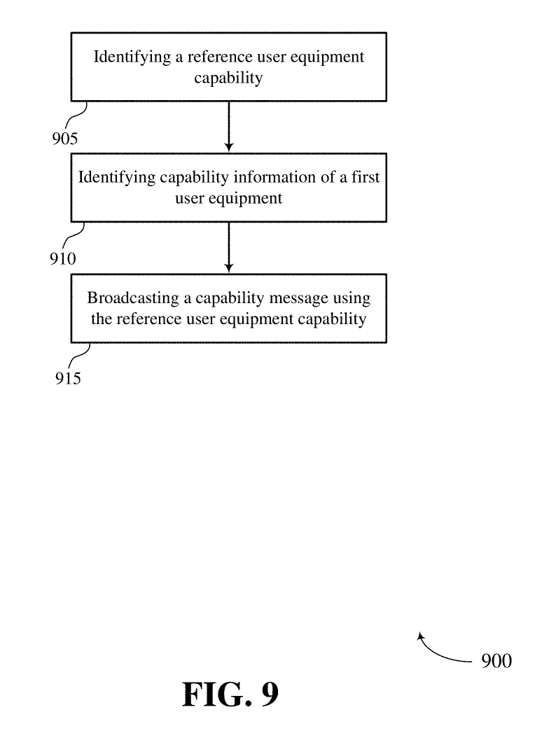

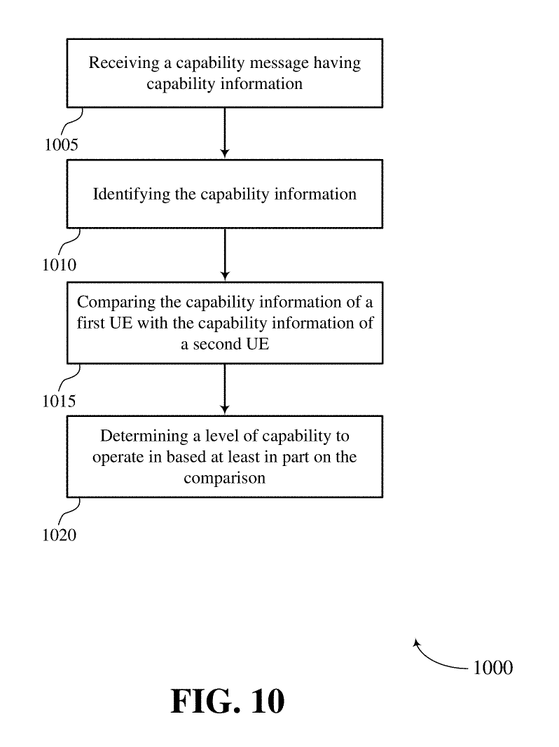

One or more components of UE 350 may be configured to perform methods of device-to-device feedback, as described in more detail elsewhere herein. For example, the controller/processor 359 and/or other processors and modules of UE 350 may perform or direct operations of, for example, process 900 of FIG. 9, process 1000 of FIG. 10 and/or other processes as described herein. In some aspects, one or more of the components shown in FIG. 3 may be employed to perform example process 900 and 1000 of FIGS. 9 and 10 and/or other processes as described herein.

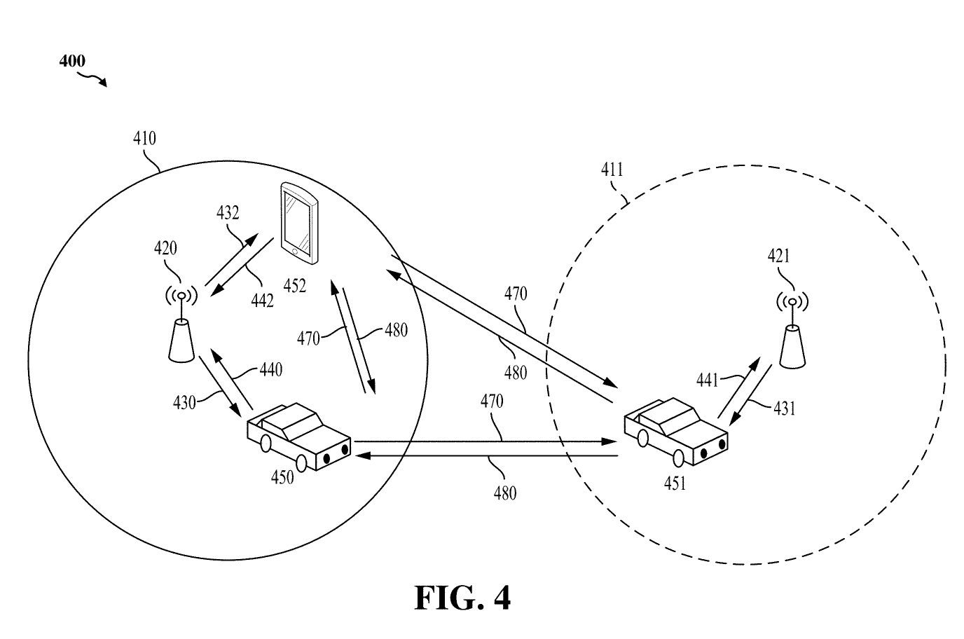

FIG. 4 is a diagram of a device-to-device (D2D) communication system 400, including V2X communication, for managing V2X capability convergence protocol, in accordance with various aspects of the present disclosure. For example, the D2D communication system 400 may include V2X communication, (e.g., a first UE 450 communicating with a second UE 451). In some aspects, the first UE 450 and/or the second UE 451 may be configured to communicate in a licensed radio frequency spectrum and/or a shared radio frequency spectrum, such as an MuLTEFire technology spectrum. The MuLTEFire technology spectrum may be unlicensed, and therefore a plurality of different technologies may use the MuLTEFire technology for communication, including LTE, LTE-Advanced, Licensed Assisted Access (LAA), Dedicated Short Range Communications (DSRC), 5G, new radio (NR), 4G, and the like. The foregoing list of technologies is to be regarded as illustrative, and is not meant to be exhaustive.

The D2D communication system 400 may utilize MuLTEFire radio access technology, LTE radio access technology or another radio access technology (e.g., 5G NR). For example, a user equipment (UE) in D2D communication may incorporate therein a UE of the LTE or 5G NR technology. In D2D communication (e.g., V2X communication or V2V communication), the UEs 450, 451 may be on networks of different mobile network operators (MNOs). Each of the networks may operate in its own radio frequency spectrum. For example, the air interface to a first UE 450 (e.g., the Uu interface) may be on one or more frequency bands different from the air interface of the second UE 451. The first UE 450 and the second UE 451 may communicate via a sidelink component carrier, for example, via the PC5 interface. In some examples, the MNOs may schedule sidelink communication between or among the UEs 450, 451 in licensed radio frequency spectrum and/or a shared radio frequency spectrum (e.g., 5 GHz radio spectrum bands). The shared radio frequency spectrum may be unlicensed, and therefore a plurality of different technologies may use the shared radio frequency spectrum for communication, including LTE, LTE-Advanced, Licensed Assisted Access (LAA), MuLTEFire, Dedicated Short Range Communications (DSRC), 5G, new radio (NR), 4G, and the like. The foregoing list of technologies is to be regarded as illustrative, and is not meant to be exhaustive. However, in some aspects, a D2D communication (e.g., a sidelink communication) between or among UEs 450, 451 is not scheduled by MNOs. In aspects, the D2D communication system 400 may further include a third UE 452. The third UE 452 may operate on the first network 410 (e.g., of the first MNO) or another network, for example. The third UE 452 may be in D2D communication with the first UE 450 and/or second UE 451.

The first network 410 operates in a first frequency spectrum and includes the first base station 420 (e.g., gNB) communicating at least with the first UE 450, for example, as described in FIGS. 1-3. The first base station 420 (e.g., gNB) may communicate with the first UE 450 via a DL carrier 430 and/or an UL carrier 440. The DL communication may be performed via the DL carrier 430 using various DL resources (e.g., the DL subframes (FIG. 2A) and/or the DL channels (FIG. 2B)). The UL communication may be performed via the UL carrier 440 using various UL resources (e.g., the UL subframes (FIG. 2C) and the UL channels (FIG. 2D)).

In some aspects, the second UE 451 may be on a different network from the first UE 450. In some aspects, the second UE 451 may be on a second network 411 (e.g., of the second MNO). The second network 411 may operate in a second frequency spectrum (e.g., a second frequency spectrum different from the first frequency spectrum) and may include the second base station 421 (e.g., gNB) communicating with the second UE 451, for example, as described in FIGS. 1-3.

The second base station 421 may communicate with the second UE 451 via a DL carrier 431 and an UL carrier 441. The DL communication is performed via the DL carrier 431 using various DL resources (e.g., the DL subframes (FIG. 2A) and/or the DL channels (FIG. 2B)). The UL communication is performed via the UL carrier 441 using various UL resources (e.g., the UL subframes (FIG. 2C) and/or the UL channels (FIG. 2D)).

For example, the first base station 420 and/or the second base station 421 may assign resources to the UEs for device-to-device (D2D) communications (e.g., V2X communications and/or V2V communications). For example, the resources may be a pool of UL resources, both orthogonal (e.g., some FDM channels) and non-orthogonal (e.g., CDM/RSMA in each channels). The first base station 420 and/or the second base station 421 may configure the resources via the PDCCH (e.g., faster approach) or RRC (e.g., slower approach).

The D2D communication (e.g., V2X communications and/or V2V communication) may be carried out via one or more sidelink carriers 470, 480. The one or more sidelink carriers 470, 480 may include one or more channels, such as a physical sidelink broadcast channel (PSBCH), a physical sidelink discovery channel (PSDCH), a physical sidelink shared channel (PSSCH), and a physical sidelink control channel (PSCCH), for example.

In some examples, the sidelink carriers 470, 480 may operate using the PC5 interface. The first UE 450 may transmit to one or more (e.g., multiple) devices, including to the second UE 451 via the first sidelink carrier 470. The second UE 451 may transmit to one or more (e.g., multiple) devices, including to the first UE 450 via the second sidelink carrier 480.

In some aspects, the UL carrier 440 and the first sidelink carrier 470 may be aggregated to increase bandwidth. In some aspects, the first sidelink carrier 470 and/or the second sidelink carrier 480 may share the first frequency spectrum (with the first network 410) and/or share the second frequency spectrum (with the second network 411). In some aspects, the sidelink carriers 470, 480 may operate in an unlicensed/shared radio frequency spectrum.

In aspects, a sidelink communication on a sidelink carrier may occur between the first UE 450 and the second UE 451. In an aspect, the first UE 450 may perform a sidelink communication with one or more (e.g., multiple) devices, including to the second UE 451 via the first sidelink carrier 470. For example, the first UE 450 may transmit a broadcast transmission via the first sidelink carrier 470 to the multiple devices (e.g., the second and third UEs 451, 452). The second UE 451 (e.g., among other UEs) may receive such broadcast transmission. Additionally or alternatively, the first UE 450 may transmit a multicast transmission via the first sidelink carrier 470 to the multiple devices (e.g., the second and third UEs 451, 452). The second UE 451 and/or the third UE 452 (e.g., among other UEs) may receive such multicast transmission. Also, additionally or alternatively, the first UE 450 may transmit a unicast transmission via the first sidelink carrier 470 to a device, such as the second UE 451. The second UE 451 (e.g., among other UEs) may receive such unicast transmission. Additionally or alternatively, in an aspect, the second UE 451 may perform a sidelink communication with one or more (e.g., multiple) devices, including the first UE 450 via the second sidelink carrier 480. For example, the second UE 451 may transmit a broadcast transmission via the second sidelink carrier 480 to the multiple devices. The first UE 450 (e.g., among other UEs) may receive such broadcast transmission. Additionally or alternatively, the second UE 451 may transmit a multicast transmission via the second sidelink carrier 480 to the multiple devices (e.g., the first and third UEs 450, 452). The first UE 450 and/or the third UE 452 (e.g., among other UEs) may receive such multicast transmission. Further, additionally or alternatively, the second UE 451 may transmit a unicast transmission via the second sidelink carrier 480 to a device, such as the first UE 450. The first UE 450 (e.g., among other UEs) may receive such unicast transmission. The third UE 452 may communicate in a similar manner.

In aspects, for example, such a sidelink communication on a sidelink carrier between the first UE 450 and the second UE 451 may occur without having MNOs allocating resources (e.g., one or more portions of a resource block (RB), slot, frequency band and/or channel associated with a sidelink carrier 470, 480) for such communication and/or without scheduling such communication. In aspects, a sidelink communication may include a traffic communication (e.g., a data communication, control communication, a paging communication and/or a system information communication). Further, in aspects, a sidelink communication may include a sidelink feedback communication associated with a traffic communication (e.g., a transmission of feedback information for a previously-received traffic communication). In aspects, a sidelink communication may employ at least one sidelink communication structure having at least one feedback symbol. The feedback symbol of the sidelink communication structure may allot for any sidelink feedback information that may be communicated in the device-to-device (D2D) communication system 400 between devices (e.g., a first UE 450, a second UE 451 and/or a third UE 452).

In aspects, a sidelink traffic communication and/or a sidelink feedback communication may be associated with one or more transmission time intervals (TTIs). In aspects, a TTI may be 0.5 ms. Although a larger or smaller value may be employed. In aspects, a TTI may be associated with and/or correspond to a communication structure slot. However, a TTI may be associated with a larger or smaller and/or different communication structure dimension and/or time unit (e.g., one or more slots, subframes, or frames). In aspects of the present methods and apparatus, a sidelink communication (e.g., sidelink traffic communication and/or a sidelink feedback communication) in the D2D communication system 400 may include at least one sidelink communication structure having a sidelink feedback symbol (e.g., to allot for communication of feedback information). For example, during a first TTI, a device in the D2D communication system 400 (e.g., the first vehicle 450) transmitting a sidelink traffic communication using the sidelink communication structure having a sidelink feedback symbol may refrain from transmitting traffic information in one or more portions of the sidelink feedback symbol. In aspects, the sidelink traffic communication may be transmitted by the first UE 450 to one or more of any remaining devices (e.g., to the second UE 451) in the D2D communication system 400. Furthermore, during the first TTI another device in the D2D communication system 400 (e.g., the second UE 451) that is transmitting a sidelink feedback communication using the wireless communication structure having a sidelink feedback symbol may transmit feedback information in one or more portions of the sidelink feedback symbol. In this manner, sidelink communication (e.g., including a sidelink traffic communication and a sidelink feedback communication) may occur efficiently, without having MNOs allocate resources for such communication, and/or without having MNOs schedule such communication.

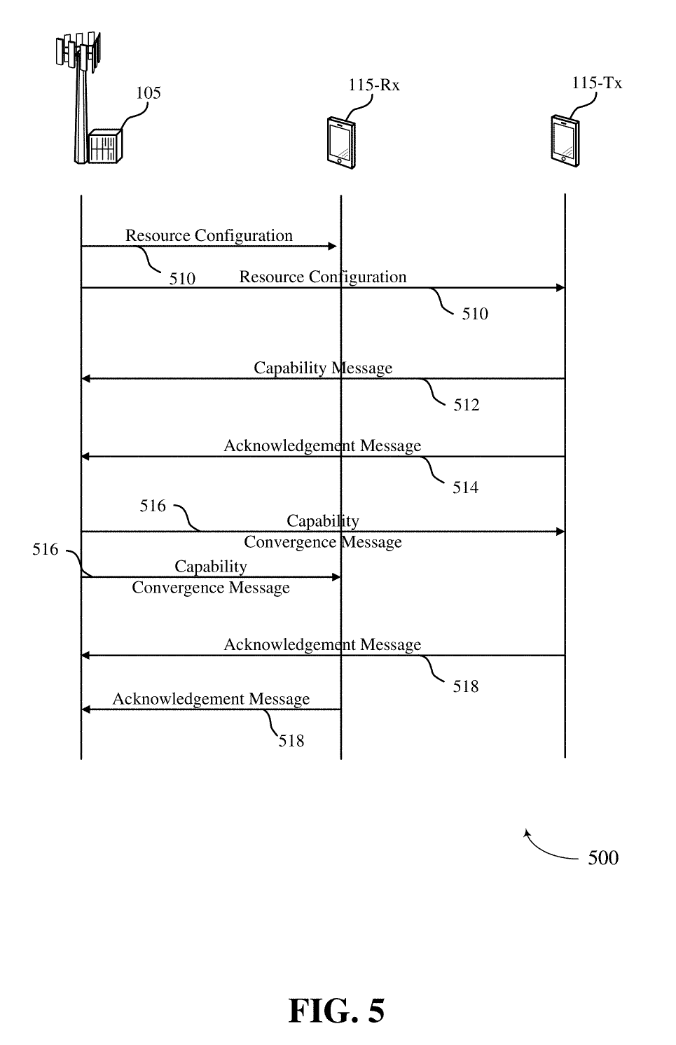

FIG. 5 is a call flow diagram 500 for a centralized management of vehicle-to-everything (V2X) capability convergence protocol, in accordance with various aspects of the present disclosure. For example, the device-to-device (D2D) communication may include vehicle-to-everything (V2X) communications, vehicle-to-vehicle (V2V) communications, or communications that are characterized by automatic data generation, exchange, processing, and actuation among machines with little or no human intervention. In another example, the device-to-device (D2D) communication may include Internet of things (IoT) communications, e.g., communications or the inter-networking of physical devices, vehicles (sometimes referred to as “connected devices” and/or “smart devices”), buildings, and other items that may be embedded with electronics, software, sensors, actuators, and network connectivity that enable these objects to collect and exchange data and other information.

In various aspect of the present disclosure, at 510, resources may be configured by a base station 105 for device-to-device (D2D) communication (e.g., V2X communications and/or V2V communications). For example, resource configuration message may be transmitted from the base station 105 to one or more user equipments (UEs) (e.g., a first UE-Tx 115 and/or a second UE-Rx 115) within a communication coverage area of the base station 105. The resource configuration message may be a physical layer message, a MAC layer message, a radio resource control (RRC) message, a non-access stratum (NAS) message, and/or an over the top (OTT) message. The resource configuration message may indicate resources that may be used by the one or more user equipments (UEs) (e.g., a first UE-Tx 115 and/or a second UE-Rx 115) for device-to-device (D2D) communications (e.g., V2X communications and/or V2V communications). The resources for device-to-device (D2D) communications (e.g., V2X communications and/or V2V communications) configured by the base station 105 may include time domain resources (e.g., subframes), frequency domain resources (e.g., subset of interlaces of frequency bands or entire frequency bands) and/or spatial domain resources (e.g., a number of layers and/or MU-MIMO).

In an aspect of the present disclosure, the base station 105 may configure time boundaries for vehicle-to-everything (V2X) capability convergence protocol in a communication coverage area of the base station 105. For example, the time boundaries for vehicle-to-everything (V2X) capability convergence protocol in a communication coverage area of the base station 105 may include one or more capability upgrade time boundaries and/or one or more capability downgrade time boundaries for a communication coverage area of the base station 105. The capability upgrade time boundary may indicate a time when one or more UEs (e.g., a first UE-Tx 115 and/or a second UE-Rx 115) within the communication coverage area of the base station 105 may contemporaneously increase a level of user equipment capability to operate in. The capability downgrade time boundary may indicate a time when one or more UEs (e.g., a first UE-Tx 115 and/or a second UE-Rx 115) within the communication coverage area of the base station 105 may contemporaneously decrease a level of user equipment capability to operate in.

In an aspect of the present disclosure, the capability upgrade time boundary may occur at a lower frequency (e.g., less occurrences) than the capability downgrade time boundary in order to ensure communication compatibility between the one or more UEs within the communication coverage area of the base station 105. In another example, the capability upgrade time boundary may occur at a higher frequency (e.g., more occurrences) than the capability downgrade time boundary in order to improve communication efficiencies between the one or more UEs within the communication coverage are of the base station 105. In other examples, the capability upgrade time boundary may occur at a same frequency (e.g., same number of occurrences) than the capability downgrade time boundary in order to ensure dynamic adjustment of user equipment capability.

In an aspect of the present disclosure, resources configured by a base station 105 for device-to-device (D2D) communication (e.g., V2X communications and/or V2V communications) may include resources for UEs to broadcast, multicast and/or transmit one or more messages (e.g., user equipment capability message and/or acknowledgement message). For example, the resources configured by the base station 105 may include periodic resources for UEs to broadcast, multicast and/or transmit one or more messages.

At 512, a capability message may be broadcasted by a first UE-Tx 115 to allow V2X capability convergence protocol. The capability message may be broadcasted by the first UE-Tx 115 using the configured resources for the first UE-Tx 115. The capability message may be broadcasted as a physical layer message, a MAC layer message, a radio resource control (RRC) message, a non-access stratum (NAS) message, and/or an over the top (OTT) message. In an example, the capability message may be broadcasted by the first UE-Tx 115 using a reference user equipment capability. The reference user equipment capability may be a minimum user equipment capability supported by all UEs. The capability message is broadcasted using the reference user equipment capability to ensure that all UEs, with varying user equipment capabilities, can properly receive (e.g., demodulate and/or decode) the capability message.

In an aspect of the present disclosure, a capability message may include user equipment capability information associated with the first UE-Tx 115. For example, the user equipment capability information associated with the first UE-Tx 115 may include a level of user equipment capability that the first UE-Tx 115 may be configured to support. In an example, the user equipment capability information associated with the first UE-Tx 115 may include a highest level of user equipment capability and/or all levels of user equipment capability that the first UE-Tx 115 may support. In another example, the user equipment capability information associated with the first UE-Tx 115 may include a preferred level of user equipment capability that the first UE-Tx 115 may want to operate in.

In an aspect of the present disclosure, a capability message may include user equipment capability information of a group of UEs within a communication coverage area. For example, the first UE-Tx 115 may previously receive one or more user equipment capability information (e.g., a minimum preferred user equipment capability) of a group of UEs within a communication coverage area (e.g., geographical coverage area of the base station 105). The first UE-Tx 115 may include the last received user equipment capability information (e.g., a minimum preferred user equipment capability) of a group of UEs within a communication coverage area in the broadcasted capability message. The capability message may also include timing information associated with the user equipment capability information of a group of UEs within a communication coverage area. For example, the capability message may include a timing of when the user equipment capability information of a group of UEs within a communication coverage area was last received by the first UE-Tx 115.

In an aspect of the present disclosure, a capability message may include a group identification (ID) of a group of UEs that is associated with a multicast session. For example, the group ID may be associated with a multicast session between the group of UEs. In an example, a group of vehicles or UEs may be in a multicast-based cooperative communication for platoon management. In such scenario, when the first UE-Tx 115 broadcasts a capability message, the capability message may include a group ID of the group of vehicles or UEs in a multicast-based cooperative communication. Therefore, each vehicle or UE in the group of vehicles or UEs in the multicast-based cooperative communication will know the capability message is for the group based at least in part on the group ID.

At 514, an acknowledgement message may be broadcasted/transmitted by a first UE-Tx 115 to allow V2X capability convergence protocol. For example, alternatively, or additionally to the capability message, the first UE-Tx 115 may broadcast/transmit an acknowledgement message. The acknowledgement message may be broadcasted/transmitted as a physical layer message, a MAC layer message, a radio resource control (RRC) message, a non-access stratum (NAS) message, and/or an over the top (OTT) message. In an example, the first UE-Tx 115 (e.g., UE 450 as shown in FIG. 4) may be in sidelink communication with a second UE (e.g., UE 451 as shown in FIG. 4), which is outside of a communication coverage of a base station 105 (e.g., base station 420). The second UE (e.g., UE 451 as shown in FIG. 4) may broadcast a capability message to the first UE-Tx 115 (e.g., UE 450 as shown in FIG. 4). The capability message may include information as described above. The first UE-Tx 115 may be adjusted to operate in a level of user equipment capability (e.g., a minimum preferred user equipment capability) of a second UE (e.g., UE 451 as shown in FIG. 4) and/or a group of UEs within a communication coverage area. The acknowledgement message may indicate that the first UE-Tx 115 adjusted to operate in a level of user equipment capability (e.g., a minimum preferred user equipment capability) of a group of UEs within a communication coverage area. For example, the first UE-Tx 115 may adjust to operate in a level of user equipment capability of a group of UEs within a communication coverage area at a upgrade capability time boundary or a downgrade capability time boundary.

At 516, a capability convergence message may be broadcasted by the base station 105 to allow V2X capability convergence protocol. For example, the base station 105 may receive one or more capability messages from one or more UEs within a communication coverage area (e.g., geographical coverage area) of the base station 105. The base station 105 may identify one or more user equipment capability information (e.g., a level of user equipment capability) included in the one or more capability message. The base station 105 may determine a minimum level of user equipment capability within the communication coverage area from the one or more user equipment capability information. The base station 105 may include the determined minimum level of user equipment capability within the communication coverage area in the capability convergence message. For example, the base station 105 may broadcast a capability convergence message to one or more UEs within a communication coverage area of the base station 105.

After the one or more UEs (e.g., within the communication coverage area (e.g., geographical coverage area) of the base station 105 received the capability convergence message, the one or more UEs (e.g., a first UE-Tx 105 and a second UE-Rx 105) may identify a minimum level of user equipment capability within the communication coverage area included in the capability convergence message. The one or more UEs (e.g., a first UE-Tx 105 and a second UE-Rx 105) may contemporaneously adjust to operate in a minimum level of user equipment capability within the communication coverage area at one or more time boundaries (e.g., capability upgrade time boundary or capability downgrade time boundary).

At 518, an acknowledgement message may be transmitted to the base station 105. For example, the first UE-Tx 115 and/or the second UE-Rx 115 may transmit an acknowledgement message to the base station 105. In an example, the acknowledgement message may indicate that the first UE-Tx 115 and/or the second UE-Rx 115 adjusted to operate in a level of user equipment capability (e.g., a minimum preferred user equipment capability) within a communication coverage area included in the capability convergence area. For example, the first UE-Tx 115 and/or the second UE-Rx 115 may adjust to operate in a level of user equipment capability within a communication coverage area at an upgrade capability time boundary or a downgrade capability time boundary.

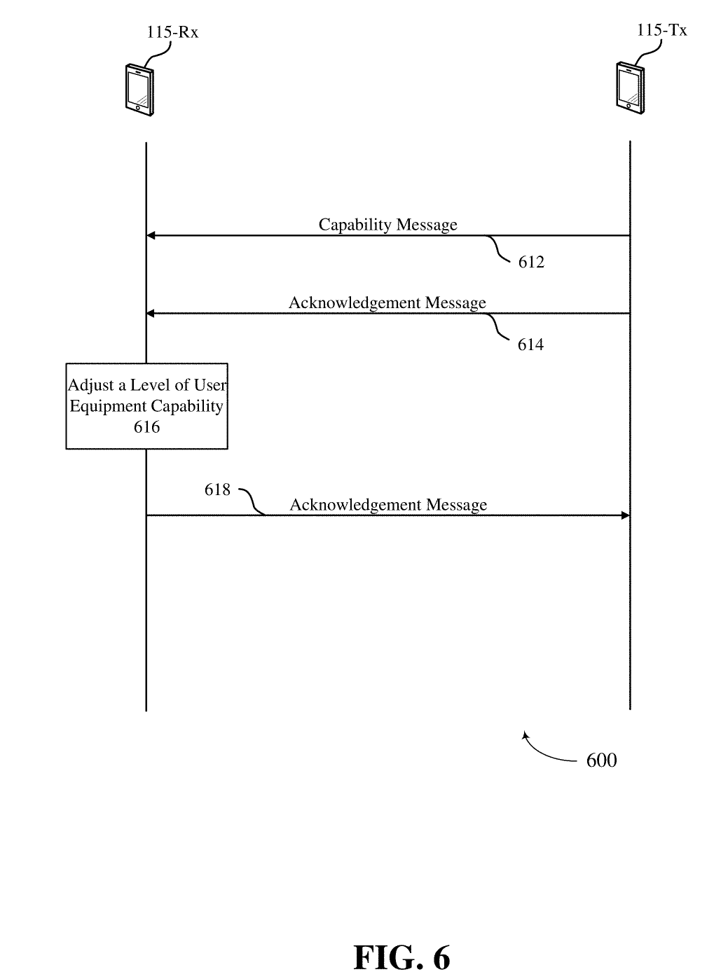

FIG. 6 is a call flow diagram 600 for a distributed management of vehicle-to-everything (V2X) capability convergence protocol, in accordance with various aspects of the present disclosure. For example, the device-to-device (D2D) communication may include vehicle-to-everything (V2X) communications, vehicle-to-vehicle (V2V) communications, or communications that are characterized by automatic data generation, exchange, processing, and actuation among machines with little or no human intervention. In another example, the device-to-device (D2D) communication may include Internet of things (IoT) communications, e.g., communications or the inter-networking of physical devices, vehicles (sometimes referred to as “connected devices” and/or “smart devices”), buildings, and other items that may be embedded with electronics, software, sensors, actuators, and network connectivity that enable these objects to collect and exchange data and other information.

At 612, a capability message may be broadcasted by a first UE-Tx 115 to allow V2X capability convergence protocol. The capability message may be broadcasted by the first UE-Tx 115 to one or more UEs (e.g., a second UE-Rx 115) within a communication coverage area (e.g., within a communication area of the first UE-Tx 115). The capability message may be broadcasted as a physical layer message, a MAC layer message, a radio resource control (RRC) message, a non-access stratum (NAS) message, and/or an over the top (OTT) message. In an example, the capability message may be broadcasted by the first UE-Tx 115 using a reference user equipment capability. The reference user equipment capability may be a minimum user equipment capability supported by all UEs. The capability message is broadcasted using the reference user equipment capability to ensure that all UEs, with varying user equipment capabilities, can properly receive (e.g., demodulate and/or decode) the capability message.

In an aspect of the present disclosure, a capability message may include user equipment capability information associated with the first UE-Tx 115. For example, the user equipment capability information associated with the first UE-Tx 115 may include a level of user equipment capability that the first UE-Tx 115 may be configured to support. In an example, the user equipment capability information associated with the first UE-Tx 115 may include a highest level of user equipment capability and/or all levels of user equipment capability that the first UE-Tx 115 may support. In another example, the user equipment capability information associated with the first UE-Tx 115 may include a preferred level of user equipment capability that the first UE-Tx 115 may want to operate in.

In an aspect of the present disclosure, a capability message may include user equipment capability information of a group of UEs within a communication coverage area (e.g., within a communication area of the first UE-Tx 115). For example, the first UE-Tx 115 may previously receive one or more user equipment capability information (e.g., a minimum preferred user equipment capability) of a group of UEs within a communication coverage area (e.g., a communication area of the first UE-Tx 115). In an aspect, the first UE-Tx 115 may receive one or more capability messages from one or more UEs within a communication coverage area. The first UE-Tx 115 may identify one or more user equipment capability information (e.g., a level of user equipment capability) included in the one or more capability message. The first UE-Tx 115 may determine a minimum level of user equipment capability within the communication coverage area from the one or more user equipment capability information. The first UE-Tx 115 may include the determined minimum level of user equipment capability within the communication coverage area in the capability message. For example, the base station 105 may broadcast a capability convergence message to one or more UEs within a communication coverage area of the base station 105.

In an aspect of the present disclosure, the first UE-Tx 115 may include the last received user equipment capability information (e.g., a minimum preferred user equipment capability) of a group of UEs within a communication coverage area in the broadcasted capability message. The capability message may also include timing information associated with the user equipment capability information of a group of UEs within a communication coverage area. For example, the capability message may include a timing of when the user equipment capability information of a group of UEs within a communication coverage area was last received by the first UE-Tx 115.

In an aspect of the present disclosure, a capability message may include a group identification (ID) of a group of UEs that is associated with a multicast session. For example, the group ID may be associated with a multicast session between the group of UEs. In an example, a group of vehicles or UEs may be in a multicast-based cooperative communication for platoon management. In such scenario, when the first UE-Tx 115 broadcasts a capability message, the capability message may include a group ID of the group of vehicles or UEs in a multicast-based cooperative communication. Therefore, each vehicle or UE in the group of vehicles or UEs in the multicast-based cooperative communication will know the capability message is for the group based at least in part on the group ID.

At 614, an acknowledgement message may be broadcasted/transmitted by a first UE-Tx 115 to allow V2X capability convergence protocol. For example, alternatively, or additionally to the capability message, the first UE-Tx 115 may broadcast/transmit an acknowledgement message. The acknowledgment message may be broadcasted/transmitted as a physical layer message, a MAC layer message, a radio resource control (RRC) message, a non-access stratum (NAS) message, and/or an over the top (OTT) message. In an example, the first UE-Tx 115 (e.g., UE 450 as shown in FIG. 4) may be in sidelink communication with a second UE-Rx 115 (e.g., UE 451 as shown in FIG. 4). The second UE-Rx 115 (e.g., UE 451 as shown in FIG. 4) may broadcast a capability message to the first UE-Tx 115 (e.g., UE 450 as shown in FIG. 4). The capability message may include information as described above. The first UE-Tx 115 may be adjusted to operate in a level of user equipment capability (e.g., a minimum preferred user equipment capability) of a group of UEs within a communication coverage area (e.g., a communication area of the first UE-Tx 115). The acknowledgement message may indicate that the first UE-Tx 115 adjusted to operate in a level of user equipment capability (e.g., a minimum preferred user equipment capability) of a group of UEs within a communication coverage area. For example, the first UE-Tx 115 may adjust to operate in a level of user equipment capability of a group of UEs within a communication coverage area at an upgrade capability time boundary or a downgrade capability time boundary.

At 616, a second UE-Rx 115 may adjust an operation (e.g., a level of user equipment capability) of the second UE-Rx 115. For example, the second UE-Rx 115 may adjust an operation (e.g., a level of user equipment capability) of the second UE-Rx 115 based at least in part on the received one or more capability messages and/or acknowledgment messages. In an example, the second UE-Rx 115 may identify capability information (e.g., a level of user equipment capability) that it's currently operating in. The second UE-Rx 115 may compare the capability information (e.g., a level of user equipment capability) that it's currently operating in with the capability information included in the capability message and/or the acknowledgment message. The second UE-Rx 115 may determine a level of capability to operate in based at least in part on the comparison of the capability information (e.g., a level of user equipment capability) that it's operating in with the capability information included in the capability message and/or the acknowledgement message. In an example, if the level of user equipment capability that the second UE-Rx 115 is currently operating in is lower than a level of user equipment capability of a group of UEs within a communication coverage area, the second UE-Rx 115 may determine to upgrade a level of user equipment capability to operate in, given that the second UE-Rx 115 supports the higher level of user equipment capability. In another example, if the level of user equipment capability that the second UE-Rx 115 is currently operating in is higher than a level of user equipment capability of a group of UEs within a communication coverage area, the second UE-Rx 115 may determine to downgrade a level of user equipment capability to operate in, given that the second UE-Rx 115 is not operating in its lowest level of user equipment capability.

In an aspect of the present disclosure, the second UE-Rx 115 may adjust an operation (e.g., a level of user equipment capability) of the second UE-Rx 115 at one or more time boundaries. For example, vehicles or UEs within a communication coverage area (e.g., a communication coverage area of the first UE-Tx 115) may be configured with time boundaries for vehicle-to-everything (V2X) capability convergence protocol in the communication coverage area. In an example, the time boundaries may be time instances where the vehicles or UEs within the communication coverage area may contemporaneously adjust an operation (e.g., a level of user equipment capability). The time boundaries for a communication coverage area may be derived/defined from at least one of a frame timing, a subframe timing, a global positing system (GPS) timing, a coordinated universal time (UTC) timing, a local timing, a long range navigation time (Loran-C) timing, and/or a temps atomique international (TAI) timing.

In an aspect of the present disclosure, the time boundaries for vehicle-to-everything (V2X) capability convergence protocol in a communication coverage area may include one or more capability upgrade time boundaries and/or one or more capability downgrade time boundaries for a communication coverage area. The capability upgrade time boundary may indicate a time when one or more UEs (e.g., a first UE-Tx 115 and/or a second UE-Rx 115) within the communication coverage area may contemporaneously increase/upgrade a level of user equipment capability to operate in. The capability downgrade time boundary may indicate a time when one or more UEs (e.g., a first UE-Tx 115 and/or a second UE-Rx 115) within the communication coverage area may contemporaneously decrease/downgrade a level of user equipment capability to operate in.

For example, the capability upgrade time boundary may occur at a lower frequency (e.g., less occurrences) than the capability downgrade time boundary in order to ensure communication compatibility between the one or more UEs within the communication coverage area of the base station 105. In another example, the capability upgrade time boundary may occur at a higher frequency (e.g., more occurrences) than the capability downgrade time boundary in order to improve communication efficiencies between the one or more UEs within the communication coverage are of the base station 105. In other examples, the capability upgrade time boundary may occur at a same frequency (e.g., same number of occurrences) than the capability downgrade time boundary in order to ensure dynamic adjustment of user equipment capability.

In an aspect of the present disclosure, a second UE-Rx 115 may adjust an operation (e.g., a level of user equipment capability) of the second UE-Rx 115 based at least in part on a timing information included in the capability message. As discussed above, the capability message may include a timing of when the user equipment capability information of a group of UEs within a communication coverage area was last received by the first UE-Tx 115. Depending on the timing of when the user equipment capability information of a group of UEs within a communication coverage area was last received by the first UE-Tx 115, the second UE-Rx 115 may vary a rate (e.g., a frequency of adjustment) of adjusting an operation (e.g., a level of user equipment capability) of the second UE-Rx 115. In an example, if timing of the user equipment capability information of a group of UEs within a communication coverage area was last received by the first UE-Tx 115 is greater than a timing threshold, the second UE-Rx 115 may adjust an operation (e.g., a level of user equipment capability) of the second UE-Rx 115 at a lower rate (e.g., taking a longer time to adjust an operation) or higher rate (e.g., taking a shorter time to adjust operation depending on whether the capability information is lower or higher than that that is currently used). For example, the second UE-Rx 115 may wait a number (e.g., greater than 1) of available time boundaries to adjust an operation (e.g., a level of user equipment capability) of the second UE-Rx 115 when the timing of the user equipment capability information of a group of UEs within a communication coverage area was last received by the first UE-Tx 115 is greater than a timing threshold. In another example, if timing of the user equipment capability information of a group of UEs within a communication coverage area was last received by the first UE-Tx 115 less than a timing threshold, the second UE-Rx 115 may adjust an operation (e.g., a level of user equipment capability) of the second UE-Rx 115 at a faster rate (e.g., taking a shorter time to adjust an operation). For example, the second UE-Rx 115 may adjust an operation (e.g., a level of user equipment capability) of the second UE-Rx 115 at the next available time boundary when the timing of the user equipment capability information of a group of UEs within a communication coverage area was last received by the first UE-Tx 115 is less than a timing threshold.

At 618, an acknowledgement message may be transmitted by a second UE-Rx 115. For example, the second UE-Rx 115 may transmit an acknowledgement message to one or more vehicles or UEs within a communication coverage area (e.g., a communication coverage area of the second UE-Rx 115). In an example, the acknowledgement message may indicate that the second UE-Rx 115 has adjusted to operate in a level of user equipment capability (e.g., a minimum preferred user equipment capability) within a communication coverage area included in the communication coverage area. For example, the second UE-Rx 115 may adjust to operate in a level of user equipment capability within a communication coverage area at a upgrade capability time boundary or a downgrade capability time boundary.

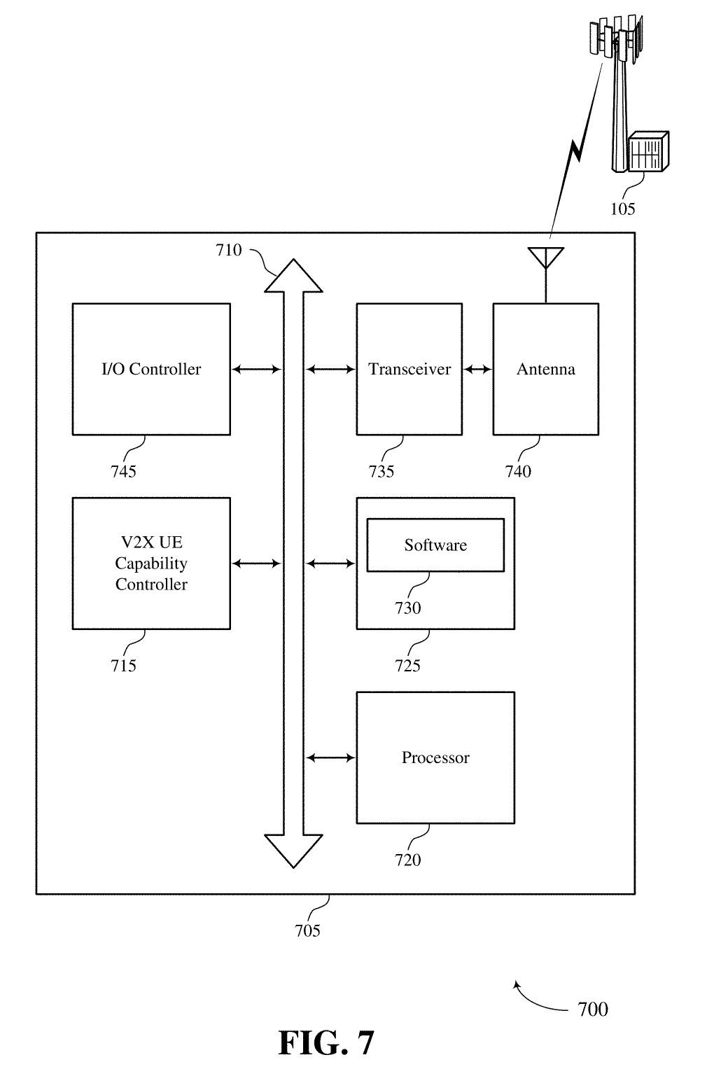

FIG. 7 shows a block diagram 700 of a wireless device 705 that manages vehicle-to-everything (V2X) capability convergence protocol in new radio (NR) in accordance with various aspects of the present disclosure. Device 705 may be an example of or include the components of a UE 115 as described above, e.g., with reference to FIGS. 1 through 6. Device 705 may include components for bi-directional voice and data communications including components for transmitting and receiving communications, including V2X UE capability controller 715, processor 720, memory 725, software 730, transceiver 735, antenna 740, and I/O controller 745. These components may be in electronic communication via one or more buses (e.g., bus 710). Device 705 may communicate wirelessly with one or more base stations 105.

Processor 720 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks for managing vehicle-to-everything (V2X) capability convergence protocol in new radio (NR)).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware or software operation such as the interaction with peripheral components or devices.

Software 730 may include code to implement aspects of the present disclosure, including code to manage vehicle-to-everything (V2X) capability convergence protocol in new radio (NR). Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may communicate bi-directionally, via one or more antennas, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets from signals received from the antennas.

In some cases, the wireless device may include a single antenna 740. However, in some cases the device may have more than one antenna 740, which may be capable of concurrently transmitting or receiving multiple wireless transmissions.

I/O controller 745 may manage input and output signals for device 705. I/O controller 745 may also manage peripherals not integrated into device 705. In some cases, I/O controller 745 may represent a physical connection or port to an external peripheral. In some cases, I/O controller 745 may utilize an operating system such as iOS®, ANDROID®, MS-DOS®, MS-WINDOWS®, OS/2®, UNIX®, LINUX®, or another known operating system. In other cases, I/O controller 745 may represent or interact with a modem, a keyboard, a mouse, a touchscreen, or a similar device. In some cases, I/O controller 745 may be implemented as part of a processor. In some cases, a user may interact with device 705 via I/O controller 745 or via hardware components controlled by I/O controller 745.

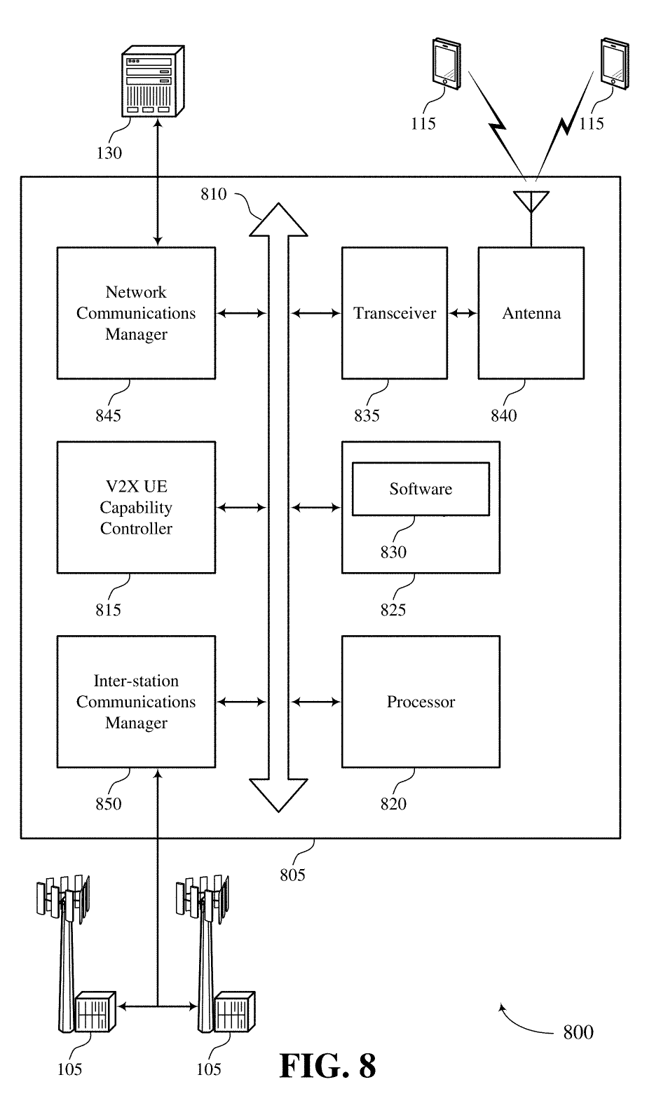

FIG. 8 shows a diagram of a system 800 including a device 805 that manages vehicle-to-everything (V2X) capability convergence protocol in new radio (NR) in accordance with various aspects of the present disclosure. Device 805 may be an example of or include the components of base station 105 as described above, e.g., with reference to FIGS. 1 to 6. Device 805 may include components for bi-directional voice and data communications including components for transmitting and receiving communications, including V2X UE capability controller 815, processor 820, memory 825, software 830, transceiver 835, antenna 840, network communications manager 845, and inter-station communications manager 850. These components may be in electronic communication via one or more buses (e.g., bus 810). Device 805 may communicate wirelessly with one or more UEs 115.

Processor 820 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 820 may be configured to operate a memory array using a memory controller. In other cases, a memory controller may be integrated into processor 820. Processor 820 may be configured to execute computer-readable instructions stored in a memory to perform various functions (e.g., functions or tasks managing vehicle-to-everything (V2X) capability convergence protocol in new radio (NR)).

Memory 825 may include RAM and ROM. The memory 825 may store computer-readable, computer-executable software 830 including instructions that, when executed, cause the processor to perform various functions described herein. In some cases, the memory 825 may contain, among other things, a BIOS which may control basic hardware or software operation such as the interaction with peripheral components or devices.

Software 830 may include code to implement aspects of the present disclosure, including code to manage vehicle-to-everything (V2X) capability convergence protocol in new radio (NR). Software 830 may be stored in a non-transitory computer-readable medium such as system memory or other memory. In some cases, the software 830 may not be directly executable by the processor but may cause a computer (e.g., when compiled and executed) to perform functions described herein.

Transceiver 835 may communicate bi-directionally, via one or more antennas, wired, or wireless links as described above. For example, the transceiver 835 may represent a wireless transceiver and may communicate bi-directionally with another wireless transceiver. The transceiver 835 may also include a modem to modulate the packets and provide the modulated packets to the antennas for transmission, and to demodulate packets from signals received from the antennas.

In some cases, the wireless device may include a single antenna 840. However, in some cases the device may have more than one antenna 840, which may be capable of concurrently transmitting or receiving multiple wireless transmissions.

Network communications manager 845 may manage communications with the core network (e.g., via one or more wired backhaul links). For example, the network communications manager 845 may manage the transfer of data communications for client devices, such as one or more UEs 115.

Inter-station communications manager 850 may manage communications with other base station(s) 105, and may include a controller or scheduler for controlling communications with UEs 115 in cooperation with other base stations 105. For example, the inter-station communications manager 850 may coordinate scheduling for transmissions to UEs 115 for various interference mitigation techniques such as beamforming or joint transmission. In some examples, inter-station communications manager 1250 may provide an X2 interface within a new radio (NR) or 5G communication network technology and/or an Long Term Evolution (LTE)/LTE-A wireless communication network technology to provide communication between base stations 105.

FIG. 9 shows a flowchart illustrating a method 900 for managing vehicle-to-everything (V2X) capability convergence protocol in new radio (NR) in accordance with various aspects of the present disclosure. The operations of method 900 may be implemented by a UE 115 or its components as described herein. For example, the operations of method 900 may be performed by a V2X UE capability controller as described with reference to FIGS. 7 and 8. In some examples, a UE 115 may execute a set of codes to control the functional elements of the device to perform the functions described below. Additionally or alternatively, the UE 115 may perform aspects of the functions described below using special-purpose hardware.

At block 905, the UE 115 may identify a reference user equipment capability. For example, the reference user equipment capability may be a minimum user equipment capability supported by all UEs within a communication coverage area. The operations of block 905 may be performed according to the methods described herein. In certain examples, aspects of the operations of block 905 may be performed by a V2X UE capability controller as described with reference to FIGS. 7 and 8.

At block 910, the UE 115 may identify capability information. For example, the capability information may include a preferred level of user equipment capability of the UE 115. Additionally or alternatively, the capability information may include capability information of a group of user equipments within a communication coverage area. Additionally or alternatively, the capability information may include a timing information associated with the capability information of a group of user equipments within a communication coverage area. Additionally or alternatively, the capability information may include a group identification of a group of user equipments that are associated with a multicast session. The operations of block 910 may be performed according to the methods described herein. In certain examples, aspects of the operations of block 910 may be performed by a V2X UE capability controller as described with reference to FIGS. 7 and 8.

At block 915, the UE 115 may broadcast a capability message using the reference user equipment capability, wherein the capability message may include the capability information of the UE 115. The operations of block 915 may be performed according to the methods described herein. In certain examples, aspects of the operations of block 915 may be performed by a transceiver, an antenna, and/or a V2X UE capability controller as described with reference to FIGS. 7 and 8.

FIG. 10 shows a flowchart illustrating a method 1000 for managing vehicle-to-everything (V2X) capability convergence protocol in new radio (NR) in accordance with various aspects of the present disclosure. The operations of method 1000 may be implemented by a UE 115 or its components as described herein. For example, the operations of method 14000 may be performed by a V2X UE capability controller as described with reference to FIGS. 7 and 8. In some examples, a UE 115 may execute a set of codes to control the functional elements of the device to perform the functions described below. Additionally or alternatively, the UE 115 may perform aspects of the functions described below using special-purpose hardware.

At block 1005, the UE 115 may receive a capability message, wherein the capability message may include capability information of another UE. The capability information may include various information as discussed above in the present disclosure. The operations of block 1005 may be performed according to the methods described herein. In certain examples, aspects of the operations of block 1005 may be performed by a receiver as described with reference to FIGS. 7 and 8.

At block 1010, the UE 115 may identify capability information of the UE 115. For example, the UE 115 may identify a level of user equipment capability that the UE 115 is currently operating in. The operations of block 1010 may be performed according to the methods described herein. In certain examples, aspects of the operations of block 1010 may be performed by a V2X UE capability controller as described with reference to FIGS. 7 and 8.

At block 1015, the UE 115 may compare the capability information of the UE 115 with the capability information of another UE included in the capability message. The operations of block 1015 may be performed according to the methods described herein. In certain examples, aspects of the operations of block 1015 may be performed by a V2X UE capability controller as described with reference to FIGS. 7 and 8.

At block 1020, the UE 115 may determine a level of user equipment capability to operate in based at least in part on the comparison. For example, the UE 115 may determine to upgrade or increase a level of user equipment capability to operate in based at least in part on the comparison. In another example, the UE 115 may determine to downgrade or lower a level of user equipment capability to operate in based at least in part on the comparison. The operations of block 1020 may be performed according to the methods described herein. In certain examples, aspects of the operations of block 1020 may be performed by a V2X UE capability controller as described with reference to FIGS. 7 and 8.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed/shared, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed:

1. A method, comprising:
identifying a reference user equipment capability;
identifying capability information of a first user equipment; and
broadcasting a capability message using the reference user equipment capability, the capability message includes the capability information of the first user equipment.

2. The method of claim 1, wherein the capability message further includes capability information of a group of user equipments within a communication coverage area.

3. The method of claim 2, wherein the capability message further includes timing information associated with the capability information of a group of user equipments within the communication coverage area.

4. The method of claim 3, wherein the timing information indicates a timing of when the capability information of a group of user equipments within the communication coverage area was last received by the first user equipment.

5. The method of claim 3, further comprising:
determining at least one of a capability upgrade time boundary or a capability downgrade time boundary based at least in part on the timing information associated with the capability information of a group of user equipments within the communication coverage area.

6. The method of claim 1, wherein the capability message further includes a group identification of a group of user equipments, the group identification is associated with a multicast session between the group of user equipments.

7. The method of claim 1, further comprising:
transmitting an acknowledging message, the acknowledgement message indicates that the first user equipment adjusted to operate in a level of capability associated with a communication coverage area.

8. The method of claim 7, the acknowledgement message is transmitted to a group of user equipments in multicast session.

9. A method, comprising:
receiving, by a first user equipment, a capability message, the capability message includes capability information of a second user equipment;
identifying, by the first user equipment, capability information of the first user equipment;
comparing, by the first user equipment, the capability information of the first user equipment with the capability information of the second user equipment; and
determining, by the first user equipment, a level of capability to operate in based at least in part on the comparison of the capability information of the first user equipment with the capability information of the second user equipment.

10. The method of claim 9, wherein the capability message further includes capability information of a group of user equipments within a communication coverage area.

11. The method of claim 10, further comprising:
comparing the capability information of a group of user equipments within the communication coverage area with the capability information of the first user equipment.

12. The method of claim 11, further comprising:
determining the level of capability to operate in based at least in part on the comparison between the capability information of a group of user equipments within the communication coverage area and the capability information of the first user equipment.

13. The method of claim 9, further comprising:
adjusting the first user equipment to operate in the determined level of capability at a time boundary of a communication coverage area.

14. The method of claim 13, wherein the time boundary of a communication coverage area includes at least one of a capability downgrade time boundary or a capability upgrade time boundary, the capability upgrade time boundary occurs at a lower frequency than the capability downgrade time boundary.

15. The method of claim 9, further comprising:
receiving an acknowledgement message from the second user equipment, the acknowledgement message indicating that the second user equipment adjusted to operate in a level of capability associated with a communication coverage area.

16. An apparatus for wireless communication, comprising:
a processor;
a memory in electronic communication with the processor; and
instructions stored in the memory and operable, when executed by the processor, to cause the apparatus to:
identify a reference user equipment capability;
identify capability information of a first user equipment; and
broadcast a capability message using the reference user equipment capability, the capability message includes the capability information of the first user equipment.

17. The apparatus of claim 16, wherein the capability message further includes capability information of a group of user equipments within a communication coverage area.

18. The apparatus of claim 17, wherein the capability message further includes timing information associated with the capability information of a group of user equipments within the communication coverage area.

19. The apparatus of claim 18, wherein the timing information indicates a timing of when the capability information of a group of user equipments within the communication coverage area was last received by the first user equipment.

20. The apparatus of claim 18, further comprising:
determining at least one of a capability upgrade time boundary or a capability downgrade time boundary based at least in part on the timing information associated with the capability information of a group of user equipments within the communication coverage area.

21. The apparatus of claim 16, wherein the capability message further includes a group identification of a group of user equipments, the group identification is associated with a multicast session between the group of user equipments.

22. The apparatus of claim 16, further comprising instructions stored in the memory and operable, when executed by the processor, to cause the apparatus to:
transmit an acknowledging message, the acknowledgement message indicates that the first user equipment adjusted to operate in a level of capability associated with a communication coverage area.

23. The apparatus of claim 22, the acknowledgement message is transmitted to a group of user equipments in multicast session.

24. An apparatus for wireless communication, comprising:
a processor;
a memory in electronic communication with the processor; and
instructions stored in the memory and operable, when executed by the processor, to cause the apparatus to:
receive a capability message, the capability message includes capability information of a second user equipment;
identify capability information of the first user equipment;
compare the capability information of the first user equipment with the capability information of the second user equipment; and
determine a level of capability to operate in based at least in part on the comparison of the capability information of the first user equipment with the capability information of the second user equipment.

25. The apparatus of claim 24, wherein the capability message further includes capability information of a group of user equipments within a communication coverage area.

26. The apparatus of claim 25, further comprising instructions stored in the memory and operable, when executed by the processor, to cause the apparatus to:
compare the capability information of a group of user equipments within the communication coverage area with the capability information of the first user equipment.

27. The apparatus of claim 26, further comprising instructions stored in the memory and operable, when executed by the processor, to cause the apparatus to:
determine the level of capability to operate in based at least in part on the comparison between the capability information of a group of user equipments within the communication coverage area and the capability information of the first user equipment.

28. The apparatus of claim 24, further comprising instructions stored in the memory and operable, when executed by the processor, to cause the apparatus to:
adjust the first user equipment to operate in the determined level of capability at a time boundary of a communication coverage area.

29. The apparatus of claim 28, wherein the time boundary of a communication coverage area includes at least one of a capability downgrade time boundary or a capability upgrade time boundary, the capability upgrade time boundary occurs at a lower frequency than the capability downgrade time boundary.

30. The apparatus of claim 24, further comprising instructions stored in the memory and operable, when executed by the processor, to cause the apparatus to:
receive an acknowledgement message from the second user equipment, the acknowledgement message indicating that the second user equipment adjusted to operate in a level of capability associated with a communication coverage area.
